(19) United States
(12) Patent Application Publication
(10) Pub. No.: US 2003/0085863 A1
(43) Pub. Date: May 8, 2003

(54) Dynamic -relaxation driving means for cholesteric liquid crystal displays

(76) Inventor: Yao-Dong Ma, San Jose, CA (US)

Correspondence Address: Yao-Dong Ma, 1866 Bethany Ave., San Jose, CA, 95132, US

(21) Appl. No.: 10/012,857

(22) Filed: Nov. 3, 2001

(51) Int. Cl. G09G 3/36; G09G 5/00

(52) U.S. Cl. 345/97; 345/208

(57) ABSTRACT

A low power consumption and fast speed driving means for cholesteric liquid crystal displays (ChLCDs). The novelty of the driving means is based upon the dynamic relaxation process of ChLCD from field induced nematic phase to the stable cholesteric phases, during which both the planar state or focal conic state can be formed simultaneously and the information can also be erased and addressed simultaneously. The driving means only consists of one erasing pulse that is higher than the phase change voltage and one addressing pulse that is lower than the phase change voltage.

### BACKGROUND OF THE INVENTION

Cholesteric liquid crystal is the earliest mosomorphic state of matter known to humankind. Cholesteric liquid crystal display (ChLCD) is a sort of Cinderella in the liquid crystal family, an old but state-of-the-art technology that started 30 years ago when people found Electric Field Induced Phase Change Effect of the cholesteric liquid crystal displays. It is characterized by the fact that the pictures may stay on the display even if the driving voltage is disconnected. The bistability also ensures a completely flicker-free display and has the possibility of infinite multiplexing to create giant displays and/or ultra-high resolution displays. The Bragg scattering effect makes CHLCD the best candidate for the reflective color display if the pitch of the ChLC is chosen in the range of visible wavelength. However, for the reasons of high driving voltage, especially the high instant driving power consumption and slow driving means, which make it impossible for the animation display and thereafter the poor electro-optical performance, it has been replaced by other displays such as twist nematic (TN) and super twist nematic (STN). Almost no one has mentioned about the cholesteric LCD until recent years' discovery of new display modes and improvements of the driving methods.

In the article of “Storage-Type Liquid Crystal Matrix Display” (SID 79 Digest, p.114-115) Tani proposes a driving method for the CHLCD. The display adopts a vertical alignment treatment and the liquid crystal pixel can be driven from stable planar structure to stable focal conic structure or from stable focal-conic structure to stable planar structure depending on the pre-designed waveform. The storage type display has the advantages of long storage time, which makes refreshing or updating of the information on the display unnecessary. However the scanning speed is relatively slow and each line needs 8 ms to address the pixels and the information can not display till the whole frame scanning is accomplished. The power consumption is high because of the two phase change voltages to the non-selection pixel and multi driving pulse sequence are over the phase change (untwist threshold) voltage.

U.S. Pat. No. 5,644,330 introduces a driving method based on static electro-optical curve of CHLCD by defining V₁ as the first threshold voltage; V₂ as the first saturate voltage; V₃ as the second threshold voltage; and V₄ as the second saturate voltage. The voltage sequence or driving waveform could drive the display from one cholesteric stable state to the other. A pulse higher than V₄ can drive the display into planar state while a pulse V₄ and followed by a pulse between V₂-V₃ will drive the display into the focal-conic state. Though the static driving principle is the same as Tani's approach, “330” teaches two bipolar square waveforms exerting to X,Y electrodes separately. When the two bipolar waveform is out-phase, the resultant voltage will be high enough to drive the display to planar state while the in-phase resultant voltage will drive the display into the focal conic state instead. Again the driving waveform is based on the static approach, i.e., the pulse width should be wide enough to drive the display from one stable state to the other stable state. As a result the scanning speed is very slow.

U.S. Pat. No. 5,748,277 divides the information writing into three stages, i.e., preparation, selection and evolution. In the first preparation phase, a pulse or series of pulses causes the liquid crystal within the picture element to align in homeotropic state and the display looks dark. The second stage is named selection step, during which the voltage added to the liquid crystal within the picture element are chosen so that the final optical state of the pixel will be either focal conic or twisted planar. In practice the voltage is chosen to either maintain the homeotropic state or reduced enough to initiate a transition to the transient twisted planar state. The third stage is evolution step, during which the liquid crystal selected to transform into the transient twisted planar state during the selection step now evolves in a focal conic state and the liquid crystal selected to remain in the homeotropic state during the selection phase continues in the homeotropic state. The voltage level of the evolution phase must be high enough to maintain the homeotropic state and permit the transient planar state to evolve into the focal conic state. After evolution stage, there comes actually holding stage where the voltage is taken to near zero or removed entirely from the pixel. The liquid crystal domains that are in the focal conic state remain in the focal conic state and those in the homeotropic state transform into a stable light reflecting planar state. In other words, the information can not be recorded till the completion of the holding stage. The bipolar waveform makes the driver circuitry very complicated and long time in maintaining homeotropic state by multiple high voltage pulses which cause the power consumption relatively high and the display takes on dark background.

U.S. Pat. No. 5,625,477 teaches a driving means of whole frame erasing and line to line addressing. The waveform for the erasing stage consists of two pulses: first high voltage and followed by a low voltage pulse. The first high voltage pulse, which is higher than the phase change voltage, induces the whole panel pixels into the field-induced-nematic state. Sequential low voltage pulse then guides the liquid crystal molecules of whole display panel from nematic state back to the stable cholesteric focal conic state or optical dark state because the display is painted black. After the whole frame is driven to dark state, there comes addressing stage. A second high voltage, which is over the phase change threshold voltage, is selectively added to the pixels into planar bright state. While the second high voltage pulse is applying to each pixel to be addressed, a second low voltage pulse is also applied to all the others during the line-to-line addressing. The driving means takes advantage of fast process from focal conic structure to the field-induced-nematic structure, then to the reflective planar structure, thus achieves fast driving speed. However, the fact that the information writing needs two high voltages, which is higher than the phase change threshold causes high power consumption. Furthermore the display works in a negative mode, i.e., write bright in a dark background, a way of blackboard writing, therefore the black bar effect is inevitable for the large information content display. From human factor viewpoint, the reflective type display should work in black information on the bright background, a way of paper writing in order to maximize the display merit of reflection to the environment light. The paper-writing mode is so popular like a PC monitor that almost any liquid crystal panel with black bars is unacceptable. Another shortcoming of frame erasing line-to-line addressing is that it can not be used as partial correction writing mode.

In the case of character writing display, according to different format, roughly more than half of the lines as spacing area doesn't need to be erased or recorded in the driving process. The frame erasing and line-to-line addressing is not the best solution because of its slow driving speed (each line needs a minimum scanning time Tₛ and the frame scanning time T_{F} which is equal to T_{S} times number of the lines).

The basic formula (V_{R}−V_{S})/2=V_{N}<V_{T} tightly links three pulses, V_{R}, V_{S} and V_{N} together, which limits the effective addressing window. For example, if V_{R} needs to be increased to gain fast switching speed, V_{N} is also increased, which causes the cross-talk effect.

### SUMMARY OF THE INVENTION

The purpose of the invention is to design a new driving means, which not only consumes less energy but also generates fast driving speed for portable cholesteric display devices. The novelty of the driving means is that it can totally or partially activate liquid crystal pixels to the planar state at the same activating time. It takes the advantage of the relaxation process from transient planar to stable planar to energize the targeted pixels into focal conic state in a way of line-to-line scanning. The whole driving waveform is composed of two basic pulses, a high voltage pulse and a low voltage pulse tailed by a series of very low non-addressing pulses. The high voltage pulse defines the voltage level higher than the field-induced-nematic threshold voltage, and low voltage pulse defines the voltage level lower than the field-induced-nematic threshold voltage. The potential difference between the high and low voltage pulses can be independently adjustable without inducing the cross-talk problem. The interval between the two pulses is adjustable depending on the relaxation process from transient planar state to stable planar state with the minimum value, τ_{nc}. Therefore, the waveform itself endows line-to-line addressing through the display matrix array. The total number of scanning lines is equal to the relaxation time divided by the addressing pulse width. One intention of the invention then is to modulate the relaxation time by using the surface conditions and driving waveforms so as to get optimum scanning lines. What makes it different from other driving means is that it uses only one high voltage pulse which is over field-induced-nematic threshold to drive the liquid crystal into homeotropic nematic phase. The following pulse is called addressing pulse, which activates the selected liquid crystal pixels to focal conic structure while the rest pixels that are not subjected to the addressing pulse will follow the original track and relax to the planar structure.

It is discovered that if a narrow voltage pulse (less than 5 ms), no matter how high the amplitude, is applied to a stable reflective planar structure, it hardly drives the liquid crystals to the focal conic structure. On the contrary, if the same narrow high voltage pulse is applied to the stable focal conic structure, it will transfer to the planar structure. Based upon the above-mentioned fact, the invention adopts a narrow high voltage pulse exerting both the original planar and focal conic pixels and ensures that all the original pixels become planar structure via a cholesteric-nematic phase transition process. The narrow high voltage pulse is termed erasing pulse, which gives the display the same starting point, i.e., field-induced-nematic phase and the tendency of reflective planar structure. Immediately after the erasing stage, there comes so-called addressing stage. The addressing stage falls in the time window of the relaxation from transient planar state to the stable planar state. The display pixels, which are recorded to bright reflection planar structure, will keep undisturbed till the completion of the relaxation. Meanwhile the display pixels, which are recorded to dark focal conic structure, will be exerted a narrow low voltage addressing pulse which is powerful enough to bifurcate the relaxation momentum from the stable planar structure to the focal conic structure instead. The relaxation time can be divided in many intermediate scales, and the addressing pulse can be entered at any scale according to the sequence of the scanning control signal. This is actually a dynamic-relaxation driving embodiment. As long as the liquid crystal domains keep transforming during the relaxation toward to the stable planar structure (first relaxation), a small amount of energy can change the roadway to the other stable cholesteric focal conic structure (second relaxation). The dynamic process of cholesteric liquid crystal molecules from field nematic to cholesteric structure can be described as follows:

When the erasing pulse is switched to zero abruptly, the liquid crystals' behavior can be divided into four stages. The first stage is the delay time at which the liquid crystals remain nematic arrangement. The second stage is formation of transient planar structure, an unstable cholesteric structure with its twist pitch roughly twice as big as the stable planar structure and its optical axis perpendicular to the display substrate. The third stage is the helical pitch restoring time, during this stage, the liquid crystal molecules wind back to the intrinsic pitch P, and the optical domain dilates from small to large. The forth stage is planar orientation stage, a relatively slow process in which the optical axis tend to align vertically to the display surface, and liquid crystal molecules tend to align parallel to the substrate. The surface characteristics such as surface critical energy, surface alignment layer and surface profile have a strong influence on the forth stage. Homogeneous alignment layer can prolong the planar orientation process, as a result the liquid crystal molecules align more parallel to the surface, and the display takes on brighter color reflection. Vertical alignment layer can speed up the forth stage but the display looks darker. Rubbing both surfaces of the display inner surface will lead the liquid crystal transform from multi-domain to single-domain or to dichroic mirror structure. Single size rubbing produces some special properties, which are favorable to the new driving means.

Mathematically, the above-mentioned process can be expressed in the following formulas: first, the time from nematic to cholesteric formation τ_{nc}=ηP²/4πK₂₂, where π represents the viscosity of liquid crystal, P the natural pitch and K₂₂ the twist elastic constant of liquid crystal. Generally τ_{nc} is in the range of 0.5-1.0 ms. The duration from cholesteric transient planar to stable planar Tᵣₚ=A ηd⁴/P² K₂₂, Where A is a surface dependent factor, d the display cell gap. Roughly, Tᵣₚ is very active factor that can be modulated by the surface condition, liquid crystal viscosity, display cell gap, the natural pitch and elastic constant. In reality, cell gap is a most sensitive factor as well as surface treatment conditions. There is a synergy effect between the cell gap and the surface effect when the cell gap is reduced to a certain level, for example, 2 micrometer, the surface effect will become more important. It is recommended in the invention that Tᵣₚ be in the range of 10-1000 ms.

The key point of the invention is to utilize the dynamic response of the liquid crystal molecules to the external exciting pulse and synchronize the information erasing and addressing process, thus reduce frame-erasing time compared with the prior art.

The other key point of the invention is to utilize the different dynamic relaxation courses from a field-induced-nematic phase to cholesteric structures. The liquid crystal molecules can be leading either to the stable planar structure through the first relaxation or to the stable focal conic structure through second relaxation by exert second addressing pulse. Both the relaxation courses coexist in the same time.

Another key point of the invention is to modify the relaxation time by using surface treatment and cell structure and other parameters to realize multi-line scanning.

Another key point of the invention is to design a driving waveform using only one high voltage pulse which is higher than the phase change threshold voltage and one low voltage pulse which is lower than the phase change threshold voltage to reduce the total pulses to the minimum.

Another key point of the invention is to design an electronic circuit to convert DC polar pulses into AC driving pulses on the display matrix that meet the needs of the driving waveform.

Another key point of the invention is to minimize the total addressing lines in frame. The black-on-white display mode allows at least 50% spacing area between two information lines to escape from being addressed. That means the scanning lines in a matrix display have been reduced at least 50% while the frame-refreshing speed is doubled, yet, the power consumption of the display is decreased 50%.

In a word, the mission of the invention is to increase driving speed, reduce the power consumption so as to make the cholesteric portable electronic display devices more applicable.

### BRIEF DESCRIPTION OF THE DRAWINGS

For a more complete understanding of the present invention, and the advantages thereof, reference is now made to the following description taken in conjunction with the accompanying drawings, in which:

FIG. 1 illustrates the optical response curve to the electric pulses;

FIG. 2 illustrates the function of the erasing pulse and electro-optical responses;

FIG. 3 illustrates the waveform of line-to-line addressing;

FIG. 4 illustrates the functions of V_{N}, V_{A} and V_{E};

FIG. 5 illustrates the power supply distribution circuitry;

FIG. 6 illustrates the actual waveform generation diagram;

FIG. 7 illustrates the other power supply distribution circuitry;

FIG. 8 illustrates the other waveform generation diagram;

FIG. 9 illustrates the re-addressing curve of gray scales.

### DETAILED DESCIPTION OF THE INVENTION

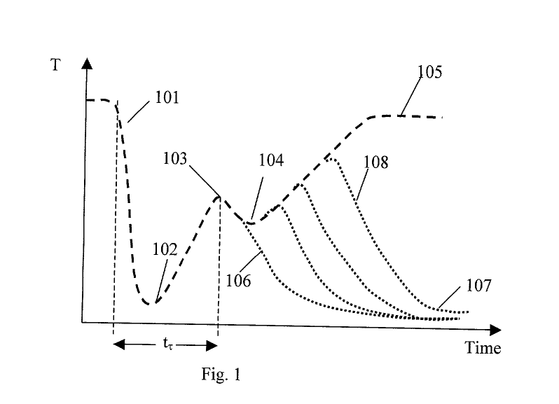

Referring first to FIG. 1, illustrated is the optical response curve to the electric pulses. Dash line 101 demonstrates the relaxation curve starting from field-induced-nematic state excited by a high voltage which is over the phase change threshold voltage. The curve reaches its first minimum 102 very quickly after the falling edge of the erasing pulse and then ramp up to a plateau 103 named transient planar state. In such transient planar state, the chiral pitch is two times larger than the stable planar state, which distinguishes the transient planar state shown in the middle of the line. After the transient planar plateau, the curve reaches second minimum 104 and followed by further development of such dynamic relaxation toward the stable planar structure 105, during which the pitch is tend to be p₀ and the optical axis of cholesteric domains tend to be vertical to the display substrate.

However, when a low voltage addressing pulse is applied to the display after the peak point of the transient planar plateau, the response curve 106 will then change its direction of relaxation and bifurcate to the focal conic structure 107. In the course of dynamic relaxation from field-induced-nematic state to cholesteric planar state, many pulses can be arranged to change the relaxation, for example line 108, towards focal conic structure. In other words, multi-line addressing will be able to realize by means of the dynamic relaxation process after the field-induced-nematic phase transition.

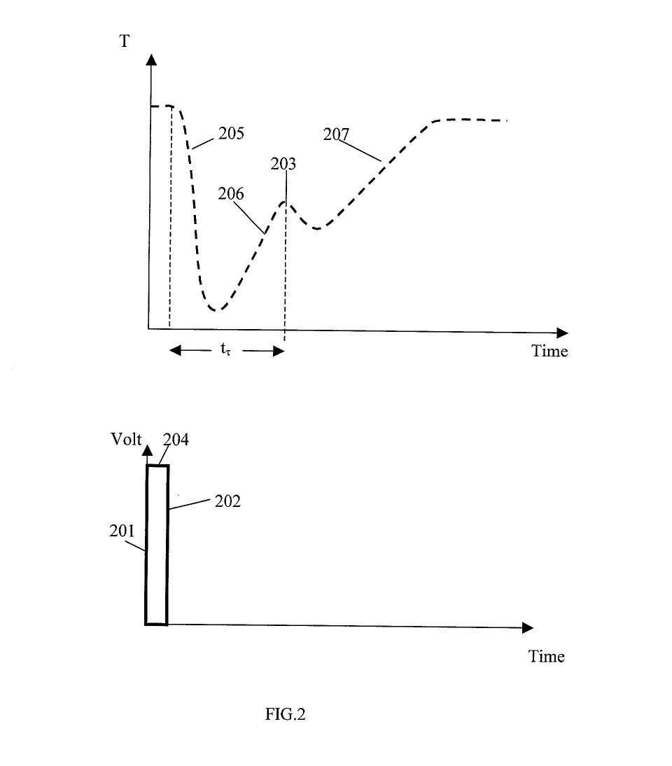

Referring to FIG. 2, illustrated is the function of the erasing pulse. The erasing pulse 201 is to drive all the information contents in cholesteric phase no matter planar or focal conic structure to the field-induced-nematic phase so that it can be called unwind pulse. The pulse height of the pulse V_{E} is higher than V_{CN}, which is defined the threshold voltage from cholesteric to nematic phase transition. The pulse has very sharp falling edge 202, but the top profile 204 can be flat (constant) or non-flat (variable) depending on the addressing method.

FIG. 2 also illustrates the electro-optical response curve to the erasing pulse 201. The curve section 205 demonstrates the reduction in transmission in the previous planar structure corresponding to the pulse. The curve section 206 demonstrates the transition from field-induced-nematic or homeotropic structure to the transient planar structure. The peak point 203 represents the formation of transient planar, a kind of cholesteric twist structure, where the pitch is roughly twice as big as the intrinsic cholesteric pitch p₀. The curve section 207 demonstrates further development of dynamic transition to stable cholesteric planar structure during which the pitch is tend to restore p₀ and the optical axis of cholesteric domains tend to be vertical to the display substrate. Concurrently the transmittance is falling first and rising to the maximum afterward.

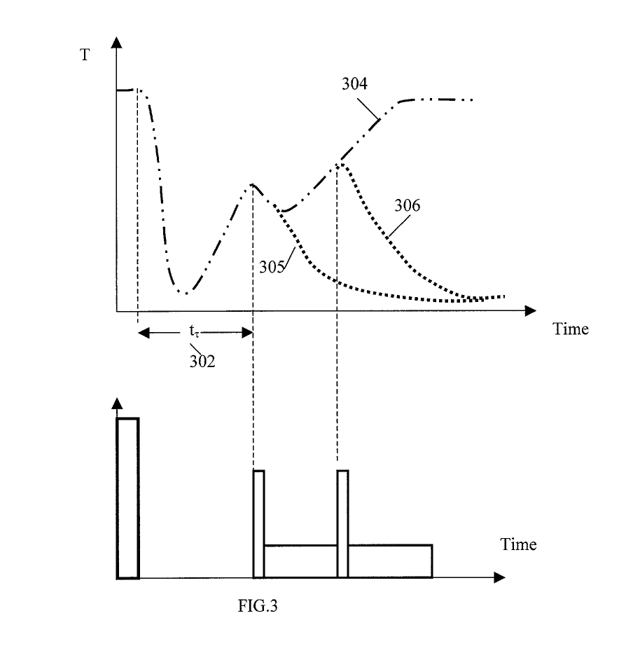

Turning now to FIG. 3, illustrated is a waveform of line-to-line addressing. The first addressing pulse 301 applies to the first line of the display after a delay time, T_{R}, 302 (the duration between the erasing falling edge and the peak point of the transient planar). The function of the addressing or writing pulse is to change the transition path and drive the addressed pixels to the focal conic structure. While the other pixels, in the same addressing line, without the addressing pulse will then be following original relaxation path back to the stable planar structure. The pulse height of the addressing or writing pulse is less than the field-induced-nematic phase change threshold, and pulse width is very narrow, which is just sufficient to leverage cholesteric molecules' dynamic transition. Base pulse 303 is non-addressing pulse, designed in the actual driving circuitry, has a positive effect in transition process.

FIG. 3 also illustrates electro-optical response to the line-to-line addressing pulse. The display pixels, which are needed to write information, will be following the curve 304 to focal conic dark state instead of the curve 305, which leads to a planar bright state. Curve 306 demonstrates the focal conic relaxation in the M-line. Timing differences among the curves 305 and 306 are occurred at the different position of the relaxation curve 304. Between pulse 301 and pulse 307 many pulses can be arranged so that multi-line addressing can be achieved by such dynamic relaxation process after the field-induced nematic phase transition.

There are three working modes for a display after the final pulse of the first frame.

First, the addressing process for a frame has been finished and the display will end up with two stable states simultaneously. The driving circuit then is “off” but the information on the display is still kept “on” due to the zero field storage effect till the refreshed information is needed to write on.

Secondly, while the final pulse of one frame is applying, the second frame information is being stored in the latch memory circuit. When the display time of the first frame comes to the end, the second frame information is led to the display by repeating the waveform of the first frame and then followed the third, fourth and so on.

Thirdly, the final pulse of the waveform only writes a fraction of one frame due to the fact that the scanning line is too long and/or partial rewriting and correction is needed. In this case the same waveform is repeated till the whole frame recording is finished. The fractionalized addressing, however, doesn't sacrifice the addressing speed because the erasing pulse of the next fraction is the accumulative result of the synthesized pulse height of the previous multiple line pulses plus current scanning pulses.

In either way of the above-mentioned information refreshing, the functions of information erasing and addressing can be realized at the same time, which is one of the most distinctive properties that differentiate the skill of the art from the prior art. In another word, the erasing pulse turns all the original pixels into the phase change homeotropic state no matter the previous information is bright or dark. It can also be called writing pulse because when it turns to zero abruptly, all the cholesteric molecules undergo a short dynamic transient relaxation process, thus creates line-to-line addressing to the bright or to the dark with the help of addressing pulse. The former, bright addressing, is directly attribute to the erasing pulse and undisturbed relaxation, while the latter, dark addressing, is attribute to the addressing pulse which changes the original relaxation path and activates the selected pixels to the dark focal conic structure instead. On the contrary, the prior arts are essentially characterized by driving the cholesteric pixels from one stable state to the other stable state.

The maximum addressing lines N can be determined by the formula N=T_{R}/Pₘᵢₙ, Where T_{R} is relaxation time and Pₘᵢₙ the minimum darkening pulse width. It is discovered that T_{R} is a strong function of surface treatment and cell gap, viscosity and elasticity of cholesteric material and pulse height. In order to get maximum addressing lines N in terms of optimal Tᵣ, the following five surface treatment approaches have been studied:

1. Homeotropic Alignment Layer for Both Inner Surface of the Substrates

The materials including organic silanes such as (C₂H₅O)₃SiC₁₈H₃₇, Cl₃SiC₁₈H₃₇ and (OH)₃SiC₁₈H₃₇, from Aldrich, which were dissolved in alcohol or IPA solution. After spin coating onto the substrates at room temperature, the thin layer is cured at 150° C. for 3 hours and then a cell sample is made by two pieces of such treated glass with the cell gap 3.5 micrometer after ChLC material is filled. The display looks dark and the T_{R} is in the range of 20-30 ms, N is less than 100. The major problem for the vertical alignment layer is limited reflectivity. It cannot be used in multi-line addressing with decent contrast ratio.

2. Non-Rubbed Homogenous Alignment Layer

The surface treatment was using standard STN alignment layer process but no buffing involved. The alignment material is PI 610 from Nissan Chemical, which was spin-coated and post-cured at 230° C. for 30 min. The cell was made in the same conditions as the above-mentioned. The liquid crystal took on two-dimensional random structure which reflects the incoming light almost hemisphere so that the viewing angle is wide and the display can be achieved unlimited gray scale level because of multistability. But the reflection or the display brightness is not satisfactory for PDA and Billboard application. The T_{R} is in the range of 30-60 ms and N is less than 200.

3. Homogenous Alignment Layer with Double Sides Rubbed

This kind of surface treatment has been used before as cholesteric dichroic mirror. When the experiment was done, it repeated the same single domain twisting structure of cholesterics: it was ideally reflected the incident light determined by Bragg reflection at a certain angle. There is no multistability because the focal conic structure is not stable in this case. Though the reflecting light was very bright and the T_{R} is in the range of 30-200 ms, the viewing angle is poor so that it is impossible to be used as a display.

4. Homogenous Alignment Layer with One Side Rubbed

The cell preparation is the same as in 2 except one side of polyimide layer is rubbed. Single side rubbing technology produces one side of single domain structure and other side multidomain structure. Non-rubbed side alignment layer gives the display bistability or multistability due to the fact that it retards the formation of the single domain of the nematic layer in the interface of the cell surface and the cholesteric liquid crystals. Rubbed side alignment layer gives the display good brightness and suitable T_{R} and N. The former can be adjusted in the range of 30-500 ms and the later could be up to 1000.

5. Large Pre-Tilt Angle Alignment Layer with One Side Rubbed

One side rubbed large pre-tilt angle display is obtained by a special alignment material and application process. One approach is to combine homeotropic silane and homogenous silane in a certain percentage and then curing in an oven with programmed profile of temperature. The other approach is to mix homeotropic silane with polymer solution such as methyl cellulose, polyvinyl alcohol at certain proportion. The pre-tilt angle could be adjusted to a certain extent. When a cell with 3 micrometer and pre-tilt angle over 10° is built, it turns out excellent driving properties as well as good optical performance.

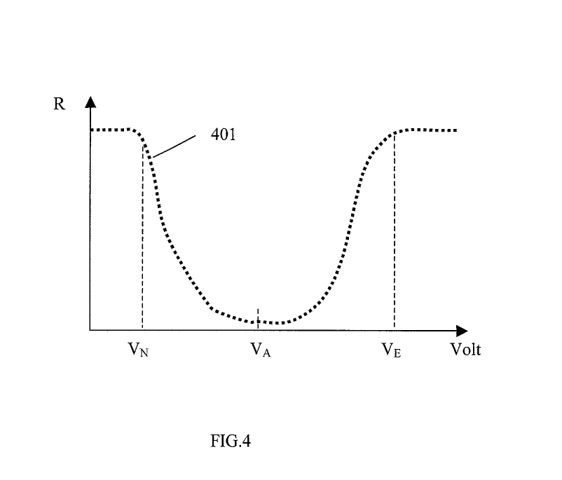

Referring to FIG. 4, illustrated is the electro-optical curve 401 where V_{N}, V_{A} and V_{E} represent non-addressing voltage, addressing voltage and erasing voltage respectively. What is different from other driving means of cholesteric display is that V_{A} and V_{N} have fixed relationship, which is determined by the following formula

V_{A}=3V_{N} (1)

Where V_{A} is the addressing voltage to drive the pixel to the focal conic structure, which has minimum reflectivity while V_{N} is the non-addressing voltage designed for maintaining the planar structure or high optical reflectivity or for facilitating the dynamic relaxation process. Formula 1 is a semi-experimental equation that derived from numerical experiment data and testing results. It also can be introduced from theoretical derivation based on some suppositions. As one part of the invention, the fixed relationship shown in formula 1 has remarkably simplified the driving circuitry and reduced the power consumption compared with that of the prior arts. Formula 1 is the foundation of the driving waveform.

V_{N}, theoretically, is not necessarily equal to the V_{T}, the transition voltage of planar to focal conic structure. First, when V_{N} is set below V_{T}, there is no flicker during the addressing process, nor cross-talk effect, where the later addressing line have no impact to the former lines. Secondly, when V_{N} is set above V_{T}, to a certain extant, there will be black marks appeared on the display. The latter addressing line has temporal impact to the former lines, but as soon as the addressing is finished, the black marks will be disappeared immediately due to the surface conditions. The condition, V_{A}>V_{T}, is especially helpful for the dynamic driving scheme, which leads to an unlimited length of the first relaxation course and, therefore, unlimited addressing line.

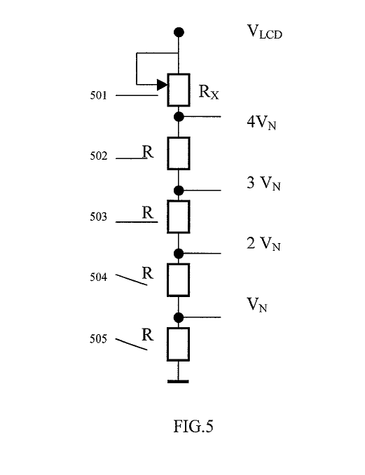

Referring to FIG. 5, illustrated is the power supply distribution circuitry. V_{LCD} is the highest voltage of the LCD power source and herein equal to the erasing voltage V_{E}.

V_{LCD}=V_{E} (2)

A tunable resistor 501 is linked between the power source and other resistors, while the rest four in series resistors 502-505 are equal in resistivity value and the linear voltage distribution of those resistors resulting in V_{N}, 2 V_{N}, 3 V_{N} and 4 V_{N}. The tunable resistor 501 enables a complete separation of V_{E} from V_{A} and V_{N}, an important part of the invention, which produces excellent optical performances over the prior art, such as (Vr−Vs)/2=V_{N}<V_{T}. The separation of V_{E} from V_{A} enables the display reaches the highest contrast ratio and superior display quality. The tunable resistor 501 may also have a function of temperature compensation, for example, thermo-sensitive resistor is to maintain the electronics working in wide temperature range. The non-addressing voltage, V_{N} is derived from the formula

3V_{N}−2V_{N}=V_{N} (3)

and the addressing voltage V_{A} is derived from the formula

4V_{N}−V_{N}=3V_{N}=V_{A} (4)

From each voltage terminal in such distribution circuitry there will be a connection of operational amplifier and logical circuitry to X driver and Y driver of the display.

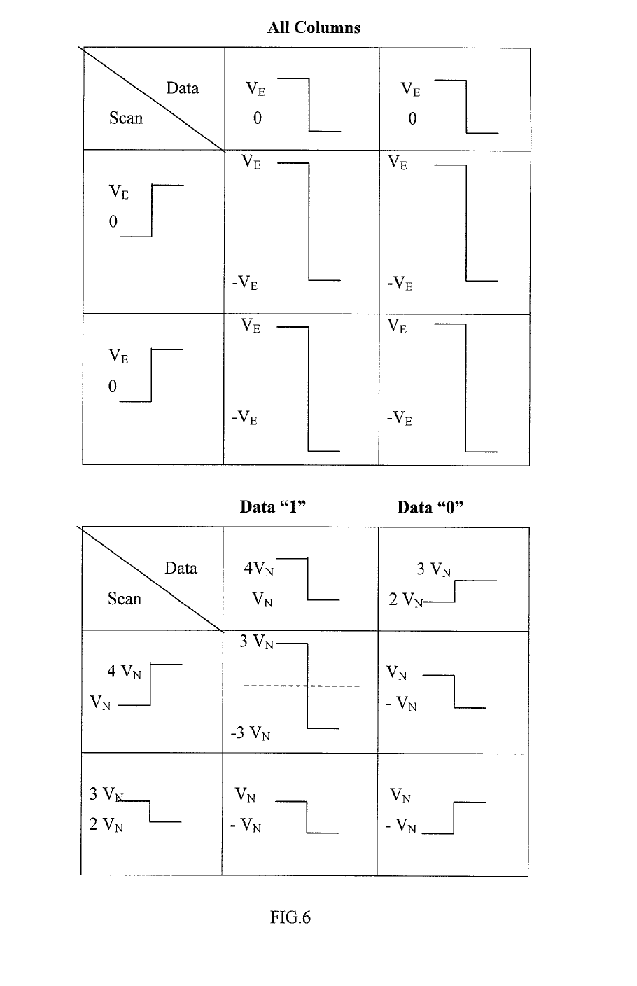

Referring to FIG. 6, illustrated is the driving waveform of the invention. During the erasing stage, AC high voltage V_{E} is applied to all the columns and scanning rolls. The DC waveform on the columns and the DC waveform on the rolls are in out-phase to form AC waveform. The waveform generated from formula 4 is applied to the selective roll and data “1” columns in a way of out phase resulting in AC pulse, V_{A}. The waveform generated from formula 3 is applied to the non-selective rolls and data “0” columns in a way of out phase, resulting in the AC pulses V_{N}. It is obvious that the waveform which crosses over the data “1” column and non-selective rolls is also constructed as an AC pulse V_{N}. All the pixels of the display during the addressing have DC-free waveforms, V_{A} or V_{N} depending on whether the cholesteric liquid crystal needs to be bifurcated into focal conic structure (V_{A}) or to further relax into planar structure (V_{N}). During the line-to-line addressing period, there is no high voltage over the field-induced-nematic threshold. Therefore, power consumption is remarkably reduced compared with that in the prior art.

The waveform demonstrated herein is the principal waveform. The DC component of the waveform should be limited as low as possible in order to ensure the display long lifetime. As a matter of fact, the novel AC waveforms of V_{A}, V_{N} and V_{E}, synthesized by X and Y drivers' DC waveform, are DC-free waveforms. The erasing pulses, V_{E}, within the block are added all display pixels while addressing pulses 301 and 307 demonstrated herein are added to the first and the “M” line respectively. There are also “M−1” pulses between the pulses 301 and 307 which are generated via scanning (X driver) signal, data (Y driver) signal and the display controller. One line data is stored in a shift register and then latched out simultaneously with the specific line signal. The line-to-line addressing process is carried out from the first line to the last within a frame. Though the current invention relates to polar driver IC, the driving means herein implicates that two types of electronic circuits can be constructed, i.e. polar and bipolar. The polar IC is much simpler and can be easily designed from CMOS semiconductor material, which is popular in VLSI chip design and similar to normal STN drivers. Bipolar is suitable for high voltage and fast speed driving scheme. Because of the simplicity of the waveform mentioned above, bipolar driver is also feasible. The high voltage X-driver is commercially available for PDP applications, which allows the driver cost to be reduced to commercial electronics level. Bipolar driver indicates the possibility of video rate display and the flexibility of multi-gray-scale display mode. Therefore, the waveform introduced in the current invention will be able to use both polar and bipolar drivers depending on the application of the final products.

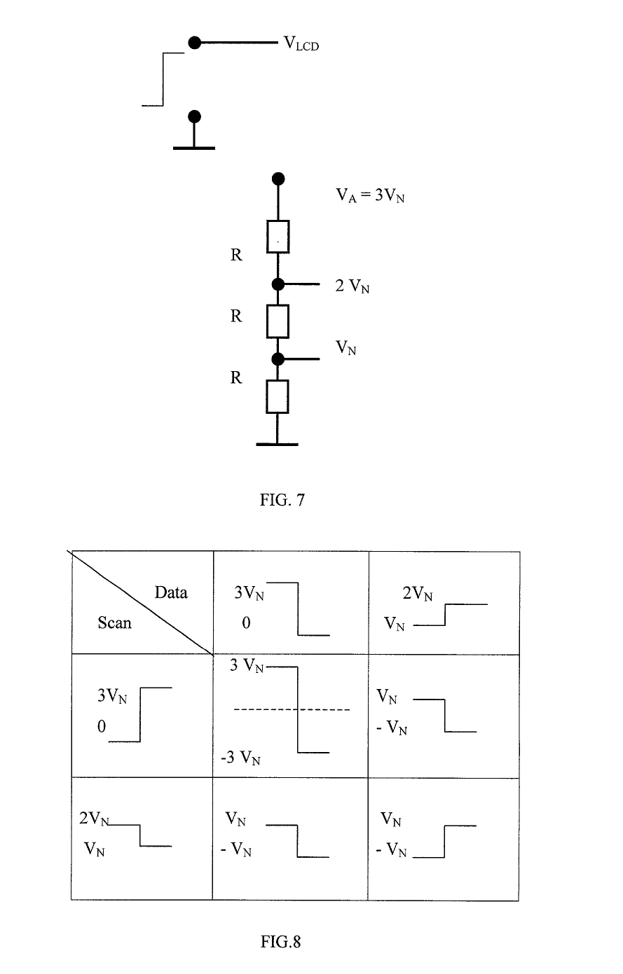

Referring to FIG. 7, illustrated is the power supply distribution circuitry. V_{LCD} is the highest voltage of the LCD power source and herein equal to the erasing voltage V_{E}. Unlike what illustrated in FIG. 5, there is another power supply source V_{A}. Three in-series resistors 701-703 are equal in value and the linear voltage distribution of those resistors results in V_{N}, 2 V_{N}, 3 V_{N}. The new circuit design not only isolates V_{E} from V_{A} and V_{N} but also simplifies electronic circuitry with fewer components. The non-addressing voltage, V_{N} is derived from the formula

2V_{N-V}_{N}=V_{N} (5)

and the addressing voltage V_{A} is simplified to formula 1, (3V_{N}=V_{A}). From each voltage terminal in such distribution circuitry there will be a connection of operational amplifier and logical circuitry to X driver and Y driver of the display.

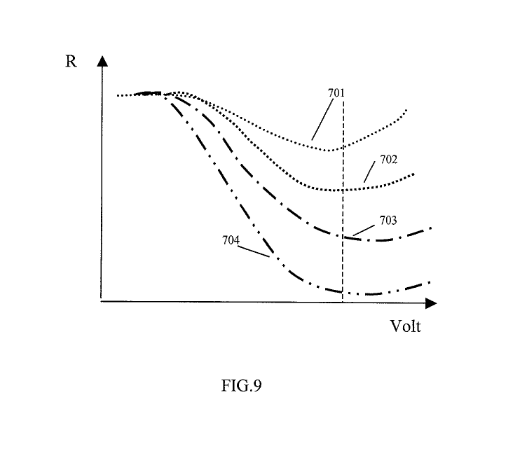

Referring to FIG. 8, illustrated is the other driving waveform of the invention. During the erasing stage, AC high voltage V_{E} is applied to all the columns and scanning rolls. The DC waveform on the columns and the DC waveform on the rolls are in out-phase to form AC waveform. The waveform generated from formula 1 is applied to the selective roll and data “1” columns in a way of out phase resulting in AC pulse, V_{A}. The waveform generated from formula 5 is applied to the non-selective rolls and data “0” columns in a way of out phase, resulting in the AC pulses V_{N}. It is obvious that the waveform which crosses over the data “1” column and non-selective rolls is also constructed as an AC pulse V_{N}. All the pixels of the display during the addressing have DC-free waveforms, V_{A} or V_{N} depending on whether the cholesteric liquid crystal needs to be bifurcated into focal conic structure (V_{A}) or to further relax into planar structure (V_{N}). During the line-to-line addressing period, there is no high voltage over the field-induced-nematic threshold. Therefore, power consumption is remarkably reduced compared with that in the prior art.

Referring now to FIG. 9, illustrated is the re-addressing curve. Following a high voltage pulse, a series of narrow addressing pulses are applied onto the display panel in a way of multiple frame addressing. In the first frame, the addressing pulse 901 gives very shallow image (round dot line) and the re-addressing in the following frame 902-904 deliver darker and darker images. Consequently, the darkest image will be obtained at the fourth frame (dash line) 904. A vivid picture with four gray levels will be finished after four frame addressing. The quantified darkness of the pixel is programmed in a graphic display and is controlled by display controller and driver circuitry. A pixel may be addressed only once or may be addressed four times depending on the location in a picture. The invention provides a driving means for gray scale display, which is essential to color display. After applying high erasing pulses to the display, the whole frame information can be re-addressed or refreshed. For example, the second frame addressing starting from the first line can be followed immediately right after the final line of previous frame has been addressed. If the same information is addressed in the following frame, it will enhance the contrast ratio of the display (for highlight application). And if different information is addressed during the following frame, gray scale will be generated. High quality picture can thus be obtained by such multiple scanning schemes. Not limited by the above-mentioned four gray scale curves, as a matter of fact, any gray scale between brightest and darkest can be realized by such driving means.

Re-addressing driving means can be applied to both traditional monochrome and black-and-white cholesteric displays as well. In the prior art of cholesteric displays, both the erasing and addressing methods rely heavily on high voltage which is over phase change threshold. This makes re-addressing almost impossible because the high voltage might destroy the previous displayed information due to erasing effect of the phase-change pulses. For some reasons such as environment temperature, cell structural surface energy etc., the traditional displays often cannot erase or write the data completely in a single addressing process which results in the display with insufficient contrast ratio and unqualified performances. This invention, however, creates a new driving means which allows information to refresh at sufficiently low power consumption. For example, during the winter, the environment temperature may be so low (the viscosity of liquid crystal material may get very high) that one frame addressing is not enough to write the information completely. Thus the second or even third re-addressing is necessary to obtain a sharp image on the display panel.

The driving means also creates an escape-addressing means. Take English version for example, seven scanning lines produce one character, while the line spacing could be seven lines, ten lines or even fourteen lines depending on the paragraph format selection. The invention creates black-on-bright writing mode which generates line-escape-addressing means. When No.7 matrix line has been scanned, the next scanning line will jump to No. 15 matrix line if the line spacing is chosen “single”. And if the line spacing is chosen “double”, then the next scanning line will be No.22 matrix line. Thus minimize the total addressing lines within one frame. The display mode avoids at least 50% spacing area between two information lines which are being addressed. That means at least 50% scanning lines in a matrix display have been reduced while the addressing speed is doubled. Therefore, at least 50% power consumption of the display is reduced. The driving waveform of the current invention takes the advantage of using only one high pulse, which drives the ChLC into nematic phase while the aforementioned prior arts adopt at least two high pulses in order to write information. From power consumption viewpoint, there is a formula: E=CV²t, where “E” represents energy consumed, “C” the capacitance, “V” the driving voltage and “t” the duration of driving time. The formula indicates that the lower “C”, especially the lower “V”, and the lower the space ratio of the high pulse, thus the lower power consumption.

Furthermore, the novel driving means has less pulse levels (2 levels). Those characteristics allow the driver circuitry to use much less charge-and-discharge transition time than that of prior art. Thus, it not only reduces the circuitry power consumption, but also decreases the cross-talk effects because of low pulse potential results in lower static power consumption. Therefore, there is a lot of synergy achieved.

The other advantage of the invention is that the driving speed is much faster than that of prior arts. The basic methodologies in prior arts are to drive the liquid crystal from one stable state to the other stable state where more energy is needed to initiate the motion or rotation of the liquid crystal molecules. On the contrary, this invention uses transient process to guide the liquid crystal molecules to the predetermined final stable state while they are in constant moving status, which substantially reduces addressing time and remarkably decreases the power consumption. Thus, such unique features as fast speed and energy efficiency make the cholesteric display one of the best candidates for most portable display devices which will substantially replace STN and reflective mode TFT in the following applications:

Firstly, PDAs (personal digital assistants) type portable displays cover the resolution in the range of ⅛, ¼, and 1/2 VGA (video graphic array). These typical products are graphic calculators, cellular phones, GPSs, electronic dictionaries, game players and so on. STN is the main player in this field, but its contrast ratio, viewing angle and readability obviously are not as good as the ChLCD. Secondly, large screen video color ChLCD displays, which can be used for out-door application, are modern city's uniqueness: different highway signs, full color sun-readable TVs and etc. For in-door applications, different size of information boards and wall TVs will be the main stream.

Thirdly, but also most importantly, ChLCD will create new display frontier in the electronic book. ChLCD takes on reflective static information display with no flicker effect, no parallax shadow, paper-like black-white and full color capability. Such information display can be made into an electronic book with excellent performance, which will cause the concept of the “book” to be changed fundamentally in the new century. Then, a student's bag will no longer be loaded with heavy books and papers but only an electronic book and PC cards.

1. A dynamic-relaxation driving means for cholesteric liquid crystal display comprising:
a. a high erasing pulse with its pulse configuration sufficiently activating display elements from field-induced-nematic structure to cholesteric planar structure through first relaxation course;
b. at least one low addressing pulse with its pulse configuration sufficiently activating display elements to cholesteric focal conic structure through bifurcating from the first relaxation course to second relaxation course;
the erasing pulse may or may not be followed immediately by the addressing pulse(s) depending dynamically on the driving means, whereby the planar structure and the focal conic structure are displayed simultaneously on display's elements through the predetermined relaxation courses.

2. The driving means according to claim 1 wherein the erasing pulse “V_{E}” is a narrow pulse with amplitude higher than the cholesteric to field-induced-nematic phase change voltage.

3. The driving means according to claim 1 wherein the addressing pulse “V_{A}” is a narrow pulse with amplitude lower than the cholesteric to field-induced-nematic phase change voltage.

4. The driving means according to claim 1 wherein the first dynamic relaxation is a controllable electro-optical response during a course from the field-induced-nematic structure to the cholesteric stable planar structure.

5. The driving means according to claim 1 wherein the second dynamic relaxation is multiple electro-optical responses during a course from cholesteric transient planar structure to cholesteric focal conic structure.

6. The driving means according to claim 1 wherein the dynamic driving means is a multi-line addressing during the first relaxation course.

7. The driving means according to claim 1 wherein the addressing pulses V_{A} start from a transient planar structure.

8. The driving means according to claim 1 wherein the planar structure and the focal conic structure are displayed simultaneously and instantly on display's elements.

9. The driving means according to claim 1 wherein the high erasing pulse is the only high voltage, which is over the field-induced-nematic threshold voltage.

10. A waveform generating circuit for the driving means comprising:
a. a DC pulse voltage source, V_{LCD};
b. a voltage distribution circuit including a tunable resisitor, Rₓ, and four resistors with approximately same value, R connected in series;
c. five pulse terminals including the source and four conjunctions between resistors, V_{LCD}, V_{N}, 2V_{N}, 3V_{N}, 4V_{N};
d. an operational amplifier and a logic switching circuit connect each terminal to X and Y driver of the cholesteric liquid crystal display;
e. a display controller enables the following functions, (1) the source terminal, V_{LCD} is applied to X and Y drivers in such a way that rising pulses “0→V_{LCD}” to all scanning lines in X driver and falling pulses “V_{LCD}→0” to all the data columns in Y driver; (2) a potential out of terminal V_{N} and 4 V_{N} is applied to X and Y drivers in such a way that the rising pulse “V_{N}→4V_{N}” to the selected scanning line in X driver and falling pulse “4V_{N}→V_{N}” to the data “1” columns in Y driver; (3) a potential out of terminal 2V_{N} and 3V_{N} is applied to X and Y drivers in such a way that the falling pulse “3V_{N}→2V_{N}” to non-selected rolls in X driver and rising pulse “2V_{N}→3V_{N}” to data “0” columns in Y driver;
whereby an AC high erasing pulse, V_{E} is exposed to the display elements by composite pulses |V_{LCD}|; whereby an AC low addressing pulse, V_{A} is exposed to the display elements by composite pulses, |4V_{N}−V_{N}|; whereby an AC non-addressing pulse V_{N} is exposed to the display elements by composite pulses, |3 V_{N}−2V_{N}| and in-phase subtraction of |4V_{N}−V_{N}| and |3V_{N}−2V_{N}|.

11. The waveform generating circuit according to claim 10 wherein the erasing pulse is V_{E}=|V_{LCD}|, which is applied to at least partial area of the display frame to activate the first relaxation course.

12. The waveform generating circuit according to claim 10 wherein the addressing pulse is V_{A}=3V_{N}=|4V_{N}−V_{N}|, which is applied to at least partial area and at least one frame of the display in a way of line-to-line addressing to activate the second relaxation course.

13. The waveform generating circuit according to claim 12 wherein the addressing pulse applied to at least partial area of the display frame means some of the spacing lines is escaped from being addressed.

14. The waveform generating circuit according to claim 11 wherein the addressing pulse applied to at least one frame of the display means multiple frame addressing, without utilizing another erasing pulse, to highlight information, create gray scale and enhance contrast ratio of the display.

15. The waveform generating circuit according to claim 10 wherein the non-addressing pulse is V_{N}=|3V_{N}−2V_{N}|, which is of positive effect to both the first relaxation course and the second relaxation course.

16. The waveform generating circuit according to claim 10 wherein the tunable resistor is a controllable component which makes V_{E} and V_{A} substantially independent.

17. The waveform generating circuit according to claim 10 wherein the waveform is governed by the following formulas
V_{E}=|V_{LCD}|

V_{A}=|4V_{N}−V_{N}|

V_{N}=|3V_{N}−2V_{N}|.

18. A waveform generating circuit for the driving means comprising:
a. a first DC pulse voltage source, V_{LCD},
b. a second DC pulse voltage source, 3V_{N};
c. a voltage distribution circuit including three resistors with approximately same value, R connected in series;
d. four pulse terminals including the first and second sources and two conjunctions between resistors, V_{LCD}, 3V_{N}, 2V_{N}, V_{N};
e. an operational amplifier and a logic switching circuit connect each terminal to X and Y driver of the cholesteric liquid crystal display;
f. a display controller enables the following functions, (1) the source terminal, V_{LCD} is applied to X and Y drivers in such a way that rising pulses “0→V_{LCD}” to all the scanning lines in X driver and falling pulses “V_{LCD}→0” to all the data columns in Y driver; (2) the source terminal 3V_{N} is applied to X and Y drivers in such a way that the rising pulse “0→V_{N}” to the selected scanning line in X driver and falling pulse “3V_{N}→0” to the data “1” columns in Y driver; (3) a potential out of terminal V_{N} and 2V_{N} is applied to X and Y drivers in such a way that the falling pulse “2V_{N}→V_{N}” to non-selected rolls in X driver and rising pulse “V_{N}→2V_{N}” to data “0” columns in Y driver;
whereby an AC high erasing pulse, V_{E} is exposed to the display elements by composite pulses |V_{LCD}|; whereby an AC low addressing pulse, V_{A} is exposed to the display elements by composite pulses, |3V_{N} |; whereby an AC non-addressing pulse V_{N} is exposed to the display elements by composite pulses, |2V_{N}−V_{N}| and in-phase subtraction of |3V_{N}| and |2V_{N}−V_{N}|.

19. The waveform generating circuit according to claim 18 wherein the first source and the second source are independent power sources.

20. The waveform generating circuit according to claim 18 wherein the waveform is governed by the following formulas
V_{E}=|V_{LCD}|

V_{A}=|3V_{N}|

V_{N}=|2V_{N}−V_{N}|.
